(19) United States
(12) Patent Application Publication
(10) Pub. No.: US 2011/0062155 A1
(43) Pub. Date: Mar. 17, 2011

(54) Method of manufacturing a fuel filler tube

(76) Inventors: Robert Walther, Burlington (CA); Detlef Stoetzel, Mississauga (DE)

(21) Appl. No.: 10/757,564

(22) Filed: Jan. 15, 2004

(30) Foreign Application Priority Data
Jan. 17, 2003 (CA) 2,417,248

(51) Int. Cl. B60K 15/04; B21D 26/033; B21D 35/00

(52) U.S. Cl. 220/86.2; 72/55; 72/61

(57) ABSTRACT

The present invention provides a method of manufacturing a fuel filler tube that significantly reduces the number of manufacturing steps. In the preferred embodiment, a tubular blank is pre-formed to an intermediate configuration approximating the form of the final fuel filler tube, and then through hydroforming the intermediate tubular preform is formed to final form. The preferred embodiment of the invention uses axial compression for controlling the axial length of the tube and its wall thickness. The method of the invention uses less material than conventional processes, and provides greater control over the parameters of the final product while eliminating many steps of the conventional process.

### FIELD OF THE INVENTION

This invention relates to methods of manufacture. In particular, this invention relates to a method of manufacturing a fuel filler tube for an automobile or other liquid fuel-powered vehicle or device.

### BACKGROUND OF THE INVENTION

Today's automobiles are still largely powered by gasoline. While there are certain exceptions, such as propane-powered vehicles, the gasoline engine remains by far the motor of choice for automobiles and other land vehicles.

One of the advantages to the gasoline engine is the widespread availability of gasoline from conveniently located filling stations. Such filling stations are typically staffed by unskilled personnel, who serve customers by pumping gasoline from a gasoline pump into the gas tank. Most filling stations also offer a self-serve function, whereby an automobile user can operate the gasoline pump himself or herself, and fill the tank of their vehicle at a lower rate.

In order to maximize the number of vehicles which can be served by a gasoline pump over a given period of time, and thus to maximize profits, such gasoline pumps are capable of dispensing gasoline quite rapidly. While this considerably increases convenience to the user, it raises a number of design issues.

Because gasoline is such a volatile fuel, safety is a primary concern in the filling of land vehicles. Automobile manufacturers have addressed this concern in many ways, one of which is to design fuel filler tubes into which the gasoline is pumped from a standardized gasoline pump nozzle. To accommodate the rapid dispensing rate and lack of skill of the typical user, these fuel filler tubes are carefully engineered to ensure the fastest and most effective transfer of fuel from the filler nozzle to the gas line that leads to the fuel tank. The ideal configuration for a fuel filler tube has been determined to provide an enlarged filling end which is cylindrical and merges eccentrically into a constricted body portion; the body portion in turn leading to an expanded, oval-shaped terminal end to which the gas line is affixed, along with an air breather line, by a cap. The body portion has an undulating cross section with precisely formed diameters and radii, which minimize splashing, eddys, mechanical resistance etc. as the fuel falls into the gas line. This design is well known to those skilled in the art.

In order to achieve this ideal configuration, the fuel filler tube should be constructed within tolerances (inside diameter, outside diameter and wall thickness) of 200 μm or less. Accordingly, fuel filler tubes are conventionally manufactured according to a hydroforming process, whereby a pre-bent tubular blank is inserted into a hydroforming mold or dye, and a pressurizing fluid such as water is injected into the tube under high pressure, forcing the tube to expand and take the shape of the dye. Hydroforming presents an important advantage in such a manufacturing process: the outside configuration of the tube is determined entirely by the shape of the hydroforming dye, and tolerances can therefore be consistently controlled. Also, hydroforming replaces the conventional half-shell construction method (stamping left and right parts and welding them together) with a single-piece construction, which avoids weld seams for better structural integrity and increased safety.

Thus, fuel filler tubes are conventionally produced according to the following steps (workflow only, without storage and logistic movements):
1) Cutting the tube to an oversized length.
2) Bending the tube to a shape that will fit into the hydroforming dye.
3) Lubricating the outside of the tube to reduce friction between the workpiece and the hydroforming dye.
4) Pre-forming the part with internal pressure (expanding to a preform)
5) Washing the tube.
6) Annealing the tube to reduce brittleness.
7) Lubricating the outside of the tube to reduce friction between the workpiece and the hydroforming dye.
8) Pressurizing the tube, forcing the tube to expand to the shape of the hydroforming dye, final form.
9) Washing the tube.
10) Trimming (cutting) the excess material from the ends of the tube using a laser or mechanical means to achieve the desired finished length.

This conventional method involves a number of steps, and is capable of producing a fuel filler tube having a wall thickness of approximately 2 mm, with tolerances of approximately 200 μm. However, this process is quite expensive, particularly over the production of hundreds of thousands of fuel filler tubes, both in terms of the equipment and labour required to produce the fuel filler tube and in the actual material used, typically stainless steel of a thickness approximating 2 mm. Furthermore, hydroforming the bent tubular blank from a tube having a uniform cross-sectional diameter to the significantly larger diameters of the inlet and terminal ends, while retaining a constricted body portion, applies considerable stress to the preformed blank which is difficult to control and can result in a large number of flawed products, with weak spots being particularly prevalent along the rounded sides of the ovate terminal end and the eccentric neck of the inlet end.

It would accordingly be advantageous to provide a method of manufacturing a fuel filler tube which requires fewer manufacturing steps and produces a product having a thinner wall thickness, but with tolerances comparable to or better than those achieved by the conventional method.

### SUMMARY OF THE INVENTION

The present invention provides a method of manufacturing a fuel filler tube that significantly reduces the number of manufacturing steps. The method of the invention can produce a fuel filler tube within the desired tolerances but having a wall thickness much smaller than that produced according to conventional methods.

In the preferred embodiment, the invention accomplishes this by preforming a tubular blank to an intermediate configuration, and then hydroforming the preformed intermediate tube to final form using a pressurizing fluid, to control the radial expansion of the tube, and axial compression for controlling the axial length of the tube and, in conjunction therewith, its wall thickness.

The method of the invention accordingly provides a less expensive and faster process for manufacturing a fuel filler tube within the exacting tolerances required to optimize fuel flow through the tube, using less material than conventional processes, and which provides greater control over the parameters of the final product. The method according to the invention does not require annealing of the tubular blank, lubrication of the tube within the hydroforming dye or washing of the tube upon removal from the hydroforming dye. The elimination of these steps results in a significant cost and time savings in the production of the fuel filler tube over a typical production run.

The invention further increases the strength of component, and thus increases safety; improves the surface quality of the finished product; produces a lighter component, which is more fuel-efficient; allows other materials (e.g. aluminium) to be used; and reduces losses from the fuel filling system, thus reducing air pollution and increasing fuel-efficiency through reduced fuel losses.

The present invention thus provides a method of manufacturing a fuel filler tube in a hydroforming dye having a cavity of a final configuration of the fuel filler tube, comprising the steps of: a. cutting a blank to a desired length; b. forming an intermediate preform having enlarged and constricted portions corresponding to enlarged and constricted portions of the fuel filler tube; c. bending the intermediate preform if required to fit into the hydroforming dye; and d. disposing the intermediate preform in the hydroforming dye and injecting the hydroforming fluid under pressure into the intermediate preform, to expand the intermediate preform to the final configuration.

In further aspects of the method of the invention: step a. involves the sub-step of cutting a flat blank with wide and narrow portions corresponding to enlarged and constricted portions of the intermediate preform and step b. comprises the sub-step of rolling the flat blank into a tube; the blank is formed from a plurality of different materials; step d. comprises the sub-step of inserting or retracting a pressurizing member in the hydroforming dye to control the length or wall thickness, or both, of the fuel filler tube; and/or the pressurizing member comprises a filler nozzle for injecting pressurized fluid during hydroforming.

The invention further provides a fuel filler tube produced according to the method.

### BRIEF DESCRIPTION OF THE DRAWINGS

In drawings which illustrate by way of example only a preferred embodiment of the invention,

FIG. 1 is a schematic view of a bent tubular blank for use in a conventional fuel filler tube manufacturing process.

FIG. 2 is a perspective view of a fuel filler tube produced according to a conventional hydroforming process before trimming of the ends.

FIG. 3 is a partial perspective view (filling end) of a flat blank pre-cut for multi-diameter tubing.

FIG. 4 is a partial perspective view (filling end) of the blank of FIG. 3 rolled into tubular form to create an intermediate tubular blank for hydroforming.

FIG. 5 is a side elevation of a fuel filler tube produced according to the method of the invention,

FIG. 6 is a perspective view of the fuel filler tube of FIG. 5,

FIG. 7 is a perspective view of a hydroforming filler nozzle according to the invention,

FIG. 8 is a perspective view of a hydroforming end nozzle according to the invention, and

FIGS. 9A and 9B are cross-section of a hydroforming dye utilizing the hydroforming nozzles of FIGS. 7 and 8.

### DETAILED DESCRIPTION OF THE INVENTION

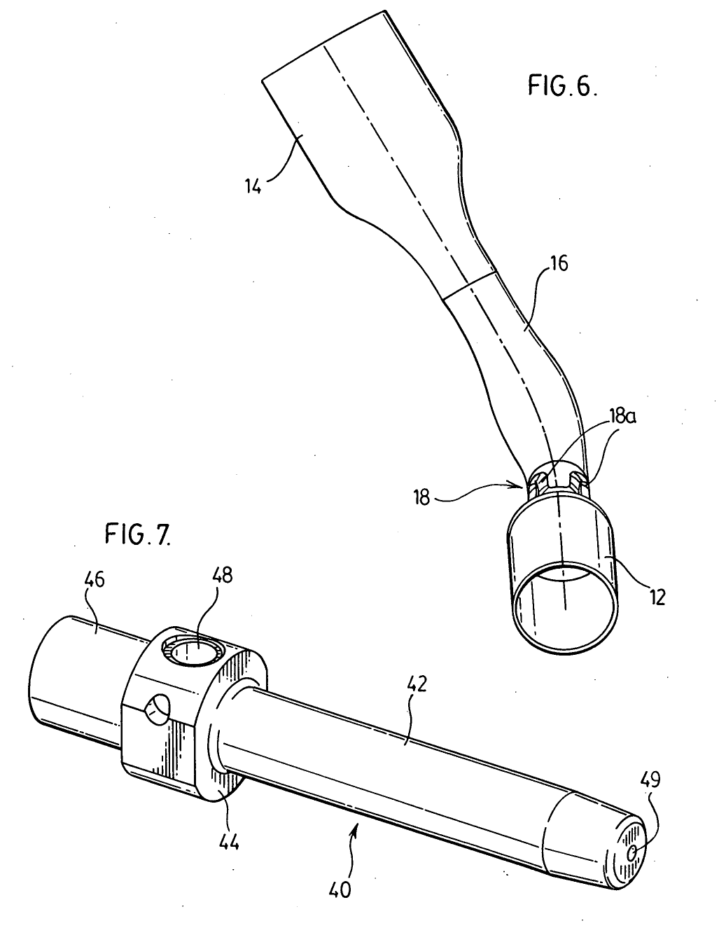

The method of manufacturing a fuel filler tube 10 according to the invention will be described with reference to the drawings. FIGS. 5 and 6 show a typical fuel filler tube 10 for an automobile, however it will be appreciated that fuel filler tubes are used in other vehicle (and nonvehicle) applications, and the method of the invention can be applied to such applications as well. The preferred material used for the fuel filler tube illustrated is 304 L stainless steel, however other materials may be suitable for any particular application and the invention is not limited thereby.

The method according to the invention involves the following steps:

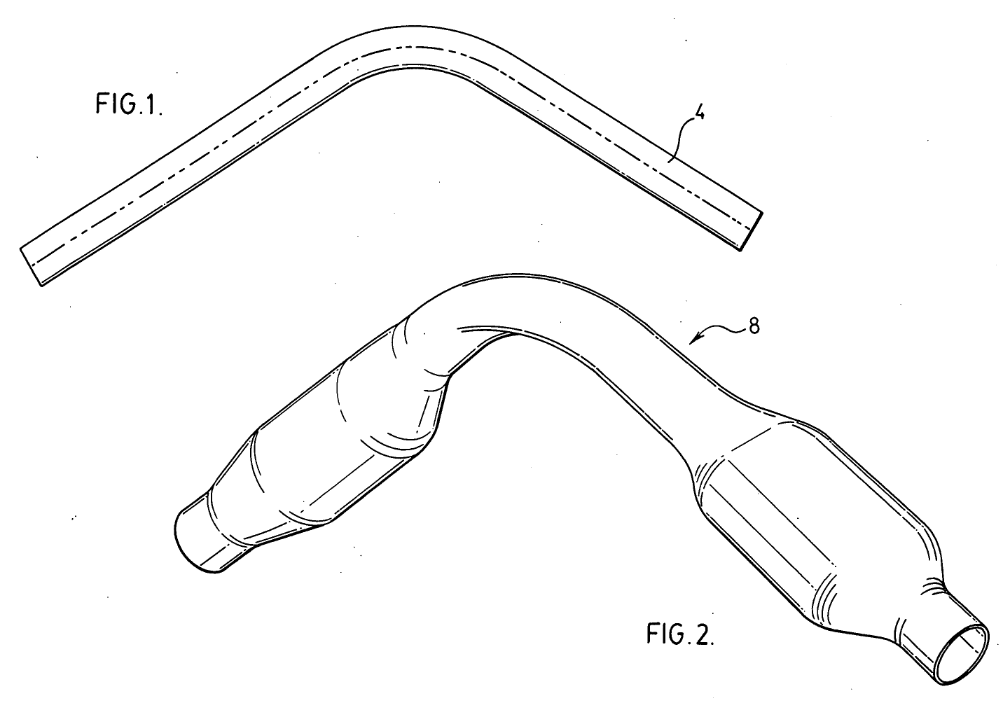

1. Cutting the blank 2 or 4 to length. A blank 2 or 4 is cut from the selected material of the desired wall thickness, taking into account the desired final length and wall thickness which will be controlled through distortion of the blank during the hydroforming process, described in greater detail below. The blank may be a flat blank 2 for multi-diameter tube forming, as shown in FIG. 4, or a tubular blank 4 such as that illustrated in FIG. 1.

2. Forming the intermediate tubular preform 20. The intermediate tubular preform 20, shown in FIG. 4, is produced according to a rough forming process, to provide enlarged and constricted portions 22, 24 smaller than, but generally approximating, the enlarged portions (filling end 12, terminal end 14) and constricted portions (body portion 16) of the final fuel filler tube 10. This can be accomplished a number of ways.

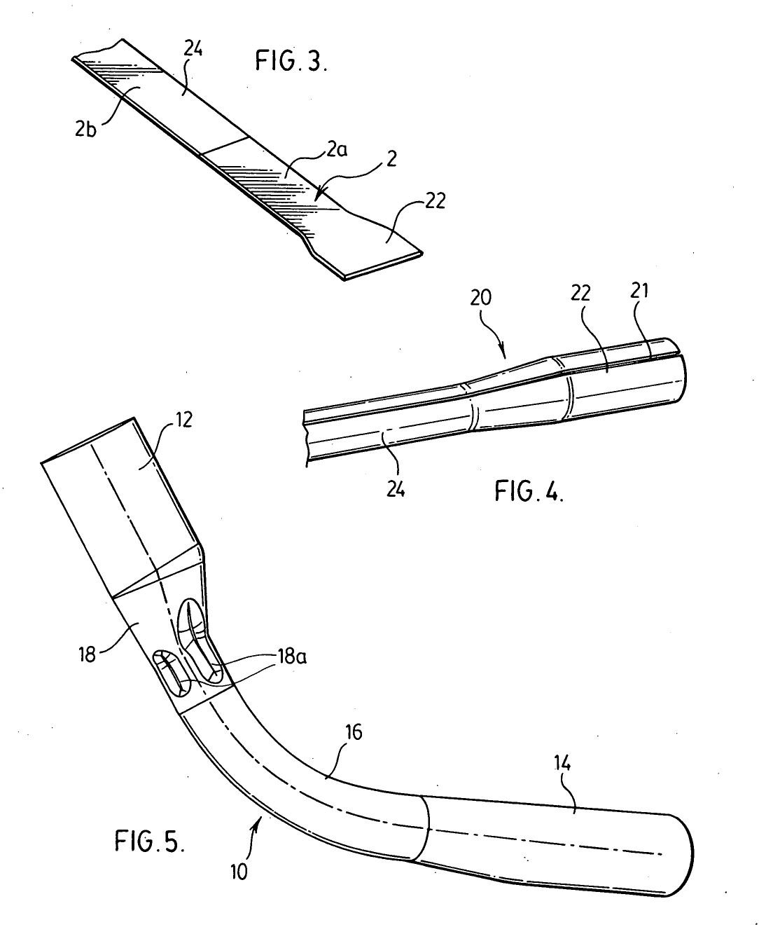

In the preferred embodiment, an intermediate tubular preform 20, illustrated in FIG. 4, is created out of a pre-shaped flat blank 2 such as that shown in FIG. 3, cut with wider portions 22 and narrower portions 24 corresponding to the larger and smaller diameters of the desired intermediate preform. The flat blank 2 is then rolled to produce the tubular preform illustrated in FIG. 4. This process is known as “multi-diameter tubing” and produces a tube that has varying diameters.

In particular, the production of multi-diameter tubing comprises the steps of cutting a shaped blank; press forming the blank into the tubular preform shape, and laser welding the seam. This process inherently eccentrically aligns the enlarged and constricted portions 22, 24, however the eccentricity is adjusted (or eliminated, as desired) in the hydroforming dye 30.

Alternatively, a tubular blank (not shown) having an outside diameter approximating the largest outside diameter of the intermediate preform is provided with a constricted portion corresponding to the constricted portion of the fuel filler tube 10. This can be accomplished by rotary swaging, spin forming and/or any other suitable technique or combination thereof.

Rotary swaging or spinning the preform, for example, typically involves the steps of cutting a tube to an oversized length; preforming the tube by rotary swaging or spinning (cold forming); and annealing the tube to reduce brittleness if required, depending on the material used.

3. Bending the intermediate tubular preform 20, if required. The intermediate tubular preform 20 is machine-bent to a configuration which will allow it to fit into the hydroforming dye 30. If the intermediate tubular preform fits into the cavity in the hydroforming dye without bending, then this step is not required.

4. Positioning the bent intermediate tubular preform 20 into the hydroforming dye 30. The preform 20 may be lubricated, if desired. However, in the method of the invention lubrication is optional, because the intermediate tubular preform 20 has been pre-formed to roughly the final configuration of the cavity in the hydroforming dye 30, so the degree of movement of the tube wall during hydroforming is minimal.

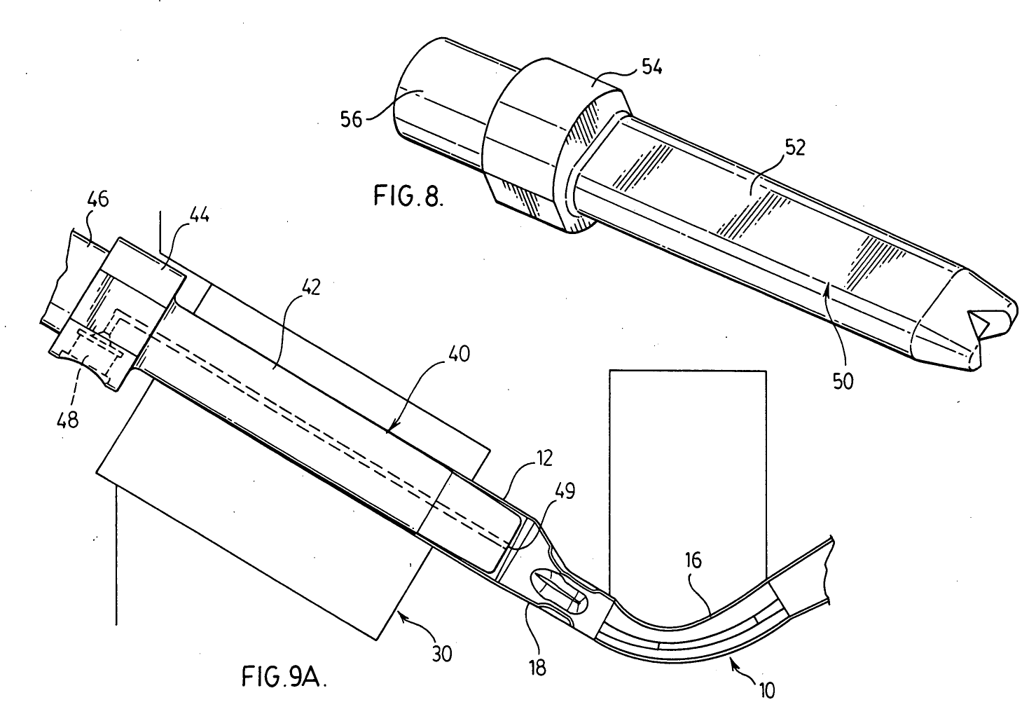

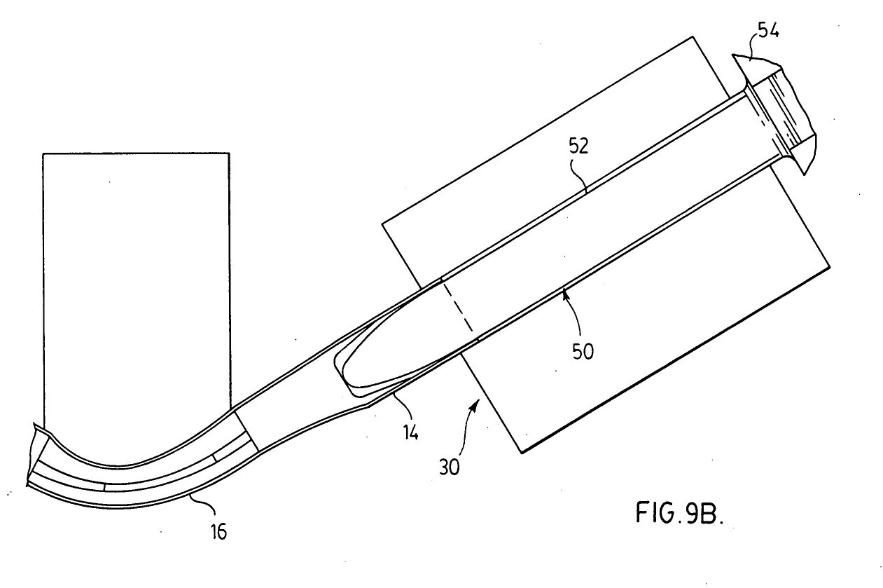

5. Inject a hydroforming fluid to pressurize the intermediate tubular preform 20. In the preferred embodiment, an injection nozzle 40, illustrated in FIG. 7, is slideably disposed in the hydroforming dye 30 at the filling end of the intermediate tubular preform 20, as shown in FIG. 9B, and an end nozzle 50, illustrated in FIG. 8, is slideably disposed in the hydroforming dye 30 at the terminal end of the intermediate tubular preform 20 as shown in FIG. 9B.

The injection nozzle 40 comprises a spigot 42 conforming in configuration to the interior of the filling end of the intermediate tubular preform 20, projecting from a shoulder 44 formed on a shank 46. An inlet 48 for the pressurized fluid, fed by a pressurizing apparatus (not shown), is in fluid communication with an outlet 49 for conveying the fluid into the interior of the intermediate tubular preform 20.

At the terminal end of the intermediate tubular preform 20, the end nozzle 50 comprises a spigot 52 conforming in configuration to the interior of the terminal end of the intermediate tubular preform 20, projecting from a shoulder 54 formed on a shank 56.

As the intermediate tubular preform 20 is pressurized the nozzles 40, 50 can be inserted into or retracted from the hydroforming dye 30, to control axial expansion and compression of the intermediate tubular preform 20. This axial compression/expansion determines not only the length of the final fuel filler tube 10, but also its wall thickness; compression of the ends of the intermediate tubular preform 20 in the hydroforming dye 30 feeds material further into the hydroforming dye 30 as the intermediate tubular preform 20 is radially expanded by the pressurizing fluid, to reduce length and increase wall thickness.

The hydroformed fuel filler tube 10 so constructed is then removed from the hydroforming dye 30, and optionally can be cleaned and inspected for quality control.

The method according to the invention not only produces a fuel filler tube 10 having the desired tolerances, rigidity, wall thickness etc. required by the automobile industry, but does so through a fraction of the number of steps involved in the conventional fuel filler tube manufacturing process.

The fuel filler tube 10 according to the invention can be produced to a thickness between 0.5 mm and 1 mm, and because the axial compression of the slidable nozzles 40, 50 allows the length of the fuel filler tube to be adjusted during hydroforming, through experimentation the blank length can be selected so as to avoid the requirement for any trimming of the finished product. This results in a savings in both process steps and material costs.

In the preferred embodiment, the desired eccentric relation between the filling end 12 and the body portion 14 of the fuel filler tube 10 is achieved as the hydroforming dye 30 is closed. However, it is also possible to produce this configuration through the hydroforming process itself.

Also, in the preferred embodiment using a flat blank 2 rolled into the intermediate tubular preform 20, as shown in FIGS. 3 and 4, preferably the seam 21 is laser welded. The position of the seam 21 may be selected to avoid running the seam through pronounced topological features; for example it may be desirable to have the seam running between dimples 18a in the neck 18 rather than along the floor of a dimple 18a. This should be considered when the flat blank 2 is cut.

The use of the flat blank 2 further allows for additional features to be incorporated into the fuel filler tube 10. For example, for crash protection and explosion resistance it may be advantageous to produce the body portion 16 from a material different from the filling end 12 or the terminal end 14 of the fuel filler tube 10. This is easily accomplished using a composite flat blank 2, such as that illustrated in FIG. 3 where, for example one portion 2a is formed form a first material and another portion 2b is formed from a second material, each material having a different strength and crash resistance.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A method of manufacturing a fuel filler tube in a hydroforming dye having a cavity of a final configuration of the fuel filler tube, comprising the steps of:
a. cutting a blank to a desired length;
b. forming an intermediate preform having enlarged and constricted portions corresponding to enlarged and constricted portions of the fuel filler tube;
c. bending the intermediate preform if required to fit into the hydroforming dye; and
d. disposing the intermediate preform in the hydroforming dye and injecting the hydroforming fluid under pressure into the intermediate preform, to expand the intermediate preform to the final configuration.

2. The method of claim 1 in which step a. involves the sub-step of cutting a flat blank with wide and narrow portions corresponding to enlarged and constricted portions of the intermediate preform and step b. comprises the sub-step of rolling the flat blank into a tube.

3. The method of claim 2 wherein the blank is formed from a plurality of different materials.

4. The method of claim 1 wherein step d. comprises the sub-step of inserting or retracting a pressurizing member in the hydroforming dye to control the length or wall thickness, or both, of the fuel filler tube.

5. The method of claim 4 wherein the pressurizing member is a nozzle for injecting pressurized fluid during hydroforming.

6. A fuel filler tube produced according to the method of claim 1.
